(19) United States
(12) Patent Application Publication
(10) Pub. No.: US 2007/0125273 A1
(43) Pub. Date: Jun. 7, 2007

(54) Lightweight concrete mix and method of using same

(75) Inventor: Arturo I. Pinto, Miami, FL (US)

Correspondence Address: AKIN GUMP STRAUSS HAUER & FELD LLP, P.O. BOX 688, DALLAS, TX, 75313-0688, US

(73) Assignee: Decorative Concrete Supply, Inc., Miami, FL (US)

(21) Appl. No.: 11/292,522

(22) Filed: Dec. 2, 2005

(51) Int. Cl. C04B 28/00; C04B 28/04; C04B 24/00; C04B 16/00

(52) U.S. Cl. 106/638; 106/713; 106/724; 106/725; 106/727; 106/802; 106/809

(57) ABSTRACT

A lightweight cementitous composition and the method of using the composition are disclosed. The composition comprises a dry mixture of a hydraulic cement component wherein the hydraulic cement components is only one type of hydraulic cement, and an aggregate component wherein the bulk density of the aggregate component is about 40 to about 60 pounds per cubic foot.

### CROSS REFERENCE TO RELATED APPLICATION

Not applicable.

### STATEMENT OF FEDERALLY SPONSORED RESEARCH/DEVELOPMENT

Not applicable.

### REFERENCES TO SEQUENCE LISTING

Not applicable.

### BACKGROUND OF THE INVENTION

For the needs or demands of various specialty applications, formulations of cementitious composition are designed to use mixtures of different hydraulic cements, as well as other additives in order to provide certain characteristics of setting times, strengths, and volume changes. Lightweight concretes are widely used as a supplement to formulations of cementitious composition. The primary use of lightweight concrete is to reduce the dead load of a concrete structure, which then allows the structural designer to reduce the size of columns, footings and other load bearing elements. These lightweight formulations can be designed to achieve similar strengths as normal weight concrete. The same is true for other mechanical and durability performance requirements.

Ready-to-use cement mixes are conventionally sold in relatively small packages for convenient use in carrying out small jobs such as minor repairs and patching applications or for the setting of fence posts and such similar endeavors. Typical examples of such cement mixes are marketed under the designation “SAKRETE” or “QUIKRETE”. Similarly, lightweight concrete compositions can be formulated as ready-to-use cement mixes.

### BRIEF SUMMARY OF THE INVENTION

In accordance with the present invention, there is provided herein a lightweight cementitious composition which can be packaged in units that can be handled easier than commonly available bagged mixes on an equal volume basis and, which upon mixing with water, produces a paste that is easily workable and sets to produce a lightweight concrete unit structure of acceptable compressive strength with a very smooth surface finish. The lightweight cementitious composition of the present invention comprises a dry mixture of only one hydraulic cement component and a lightweight aggregate component. The hydraulic cement component can be Portland cement Type I, Type II, Type III, Type K, Type M, Type N, or Type S, which is about 35% to about 40% of the mixture. The lightweight aggregate component has a bulk density of about 40 to 60 pounds per cubic foot (ppcf). The lightweight aggregate is about 55% to about 60% of the mixture. After being mixed with water in an amount of 8 to 9 quarts of water per 80 pounds of mixture, the formulation of the present invention produces about 1 cubic foot of concrete structure with a compressive strength having a range of about 2500 to 6200 pounds per square inch (ppsi).

In one embodiment of the improved formulation of lightweight concrete mixture, in addition to a hydraulic cement component and a lightweight aggregate in the mixture, a plasticizer of about 1% to about 2% of the cement component, a set control accelerator of about 6% of the cement component, a pozzolan of about 1% to about 10% of the cement component, and a cement modifier of about 2% to about 15% of the cement component are supplemented to the mixture. The concrete structure resulting from mixing a predetermined amount of water with the improved formulation of the lightweight concrete mixture possesses several advantages over other products. Specifically, a concrete structure made with the disclosed component significantly shortens the concrete set time, is about 30% to about 40% lighter than regular concrete, increases concrete yield, and has an acceptable or even higher compressive strength than regular concrete.

In another embodiment of the present invention, white Portland Type I cement is used to formulate a lightweight concrete mixture, the white color cement provides flexibility of mixing integral colors, acid stains or dyes to make the end product brighter. The composition comprising white Portland Type I cement is preferably used for making a lightweight concrete countertop and the like in an indoor setting. A person of ordinary skill in the art will understand that the components of the present invention can be used for making other products suitable for use in indoor and outdoor settings without departing from the scope and spirit of the present invention.

### DETAILED DESCRIPTION OF THE INVENTION

While the making and using of various embodiments of the present invention are discussed in detail below, it should be appreciated that the present invention provides for inventive concepts capable of being embodied in a variety of specific contexts. The specific embodiments discussed herein are merely illustrative of specific manners in which to make and use the invention and are not to be interpreted as limiting the scope of the instant invention.

The claims and specification describes the invention presented and the terms that are employed in the claims draw their meaning from the use of such terms in the specification. The same terms employed in the prior art may be broader in meaning than specifically employed herein. Whenever there is a question between the broader definition of such terms used in the prior art and the more specific use of the terms herein, the more specific meaning is meant.

The present invention provides a lightweight cementitious composition in the form of a dry mixture which can be packaged in dry form in relatively lightweight bags, e.g., 40 pound to 80 pound bags, and which can be mixed with a defined amount of water to produce a cementitious slurry or paste. Upon mixing with a defined amount of water, the resulting mixture produces a nice cream, or fat layer at the top which can be easily troweled smooth, ground after setting, and produces a very smooth finish without bug holes or other imperfections. Moreover, the mixture is easy to pour and spread and to vibrate without producing segregation. The resulting concrete product has strength comparable to or exceeding most commercial mixes such as those marketed under the designation “SAKRETE” and “QUIKRETE”, which yield a compressive strength between 4,000 PSI and 5,000 PSI. The formulation of the present invention yields a compressive strength of between 2,500 PSI and 6200 PSI, more specifically, about 5,500 PSI.

The formulation of the present invention specifically shortens the set time to about 4 hours at 78 degrees F. The formulation of the present invention is specifically suitable for making lightweight concrete countertops. The present invention saves labor costs, reduces idle time and has other advantages such as, but not limited to, allowing the contractor to remove the forms sooner to finish the sides of the countertop and to be able to grind the top smooth sooner.

Another important feature is the weight of the mix. The end product of the present invention is about 30% to about 40% lighter than regular concrete. Such weight reduction range puts much less strain on cabinets or cabinet bases when a countertop is made and installed. This weight reduction also reduces load and increases efficiency of labor and cement capacity.

Yet another important feature is the yield of the mix. Typically an 80 pound bag of regular concrete (SAKRETE for example) will yield close to 0.60 cubic foot. In comparison, an 80 pound bag of the mix of the present invention yields about 1.0 cubic foot, which represents over 1.6 times the yield of ordinary concrete or an increase of approximately 66% of additional coverage area.

In accordance with the present invention, the cementitious composition comprises a dry mixture of one type of hydraulic cement component and a lightweight aggregate component. The cement component comprises one of Portland cement constituents, preferably white Portland cement type I. Other types of white or gray Portland type I, II, III, S, N, M, or K may be used. These cement components must meet United States Standards ASTM-C-150. Portland cement consists mainly of tricalcium silicate and dicalcium silicate. The strength of the cementing agent is a function of the water-cement ratio. Therefore, strength will vary widely depending upon the amount of water used. To obtain maximum strength, the water-cement ratio should be kept as low as possible.

Formation of concrete is a process by which the voids between the particles of the coarse aggregate are filled by the fine aggregate, and the whole is cemented together by the binding action of the cement. Portland cement is a closely controlled chemical combination of calcium, silicon, aluminum, iron and small amounts of other compounds, to which gypsum is added in the final grinding process to regulate the setting time of the concrete. Some of the raw materials used to manufacture cement are limestone, shells, and chalk or marl, combined with shale, clay, slate or blast furnace slag, silica sand, and iron ore. Lime and silica make up approximately 85 percent of the mass.

Type I is a general purpose Portland cement suitable for all uses where the special properties of other types are not required. Type I is used where cement or concrete is not subject to specific exposures, such as sulfate attack from soil or water, or to an objectionable temperature rise due to heat generated by hydration. Type I cement is used in many applications including pavements and sidewalks, reinforced concrete buildings, bridges, railway structures, tanks, reservoirs, culverts, sewers, water pipes and masonry units.

Type II Portland cement is used where precaution against moderate sulfate attack is important, as in drainage structures where sulfate concentrations in ground waters are higher than normal but not unusually severe. Type II cement will usually generate less heat at a slower rate than Type I. With this moderate heat of hydration (an optional requirement), Type II cement can be used in structures of considerable mass, such as large piers, heavy abutments, and heavy retaining walls. Use of Type II cement will reduce temperature rise, especially important when the concrete is placed in warm weather.

Type III is a high-early strength Portland cement that provides high strengths at an early period, usually a week or less. Type III is used when forms are to be removed as soon as possible, or when the structure must be put into service quickly. In cold weather, use of Type III permits a reduction in the controlled curing period. Although richer mixtures of Type I cement can be used to gain high early strength, Type III, high-early-strength Portland cement, may be more inexpensive and provide more satisfactorily results. Specifications for three types of air-entraining Portland cement (Types IA, IIA, and IIIA) are given in ASTM C 150. These types of air-entraining Portland cement correspond in composition to ASTM Types I, II, and III, respectively, except that small quantities of air-entraining materials are inter ground with the clinker during manufacture to produce minute, well-distributed, and completely separated air bubbles. These cements produce concrete with improved resistance to freeze-thaw action.

Type IV is a low heat of hydration cement for use where the rate and amount of heat generated must be minimized. Type IV cement develops strength at a slower rate than Type I cement. Type IV cement is intended for use in massive concrete structures, such as large gravity dams, where the temperature rise resulting from heat generated during curing is a critical factor.

Type V is a sulfate-resisting cement used only in concrete exposed to severe sulfate action—principally where soils or ground waters have a high sulfate content.

Expansive cement, as well as expansive components, is a cement containing hydraulic calcium silicates that, upon being mixed with water, forms a paste, that during the early hydrating period occurring after setting, increases in volume significantly more than does Portland cement paste. Expansive cement is used to compensate for volume decrease due to shrinkage and to induce tensile stress in reinforcement. Expansive cement concrete is used to minimize cracking caused by drying shrinkage in concrete slabs, pavements, and structures is termed shrinkage-compensating concrete. As defined in ASTM C 845, expansive cement Type K contains anhydrous calcium aluminate, Type M contains calcium aluminate and calcium sulfate, and Type S contains tricalcium aluminate and calcium sulfate. Physical and mechanical properties of shrinkage compensating concrete are similar to those of Portland cement concrete. Tensile, flexural, and compressive strengths are comparable to those in Portland cement concrete. Air-entraining admixtures are as effective with shrinkage-compensating concrete as with Portland cement in improving freeze-thaw durability.

In the present invention, white cement is chosen as the preferred cement because of its color. The composition of the present invention, when used for countertops, will likely be combined with colorants such as Iron Oxides, Acid Stains, Concrete Dyes and other materials. By using white cement, the end product will have a lighter, more appealing color that may be manipulated in more directions than if it was gray. However, this does not limit the composition of the present invention to only white cement as on occasion the need may arise to produce a more diverse formula. The preferred white cement will be of Portland cement Type I, as this cement provides most of the qualities required to the specification for making countertops. The white Portland cement used in the present invention comprises a content of between about 2% and about 4% gypsum. However, Types IA, IIA, IIIA, Type II, Type III, Type S, Type K, Type N, Type M and high alumina cements may be used to adjust setting time, compensate for shrinkage, provide better workability, improve water retention, increase high early strength, reduce curing time, provide air entraining, and increase compressive strength.

Besides Portland cement, concrete may contain other cementitious materials including fly ash, a waste byproduct from coal burning electric power plants; ground slag, a byproduct of iron and steel manufacturing; and silica fume, a waste byproduct from the manufacture of silicon or Ferro-silicon metal. The concrete industry uses these materials, which would normally have to be disposed in landfill sites. The materials participate in the hydration reaction and significantly improve the strength, permeability and durability of concrete.

The key to achieving a strong, durable concrete rests on the careful proportioning and mixing of the ingredients. A concrete mixture that does not have enough paste to fill all the voids between the aggregates will be difficult to place and will produce rough, honeycombed surfaces and porous concrete. A mixture with an excess of cement paste will be easy to place and will produce a smooth surface; however, the resulting concrete will be more likely to crack and will not be economical. A properly proportioned concrete mixture will possess the desired workability for the fresh concrete and the required durability and strength for the hardened concrete. Typically, a mixture is by volume about 10% to about 15% cement, about 60% to about 75% aggregates and about 15% to about 20% water. Entrained air bubbles in many concrete mixtures may also take up another 5% to 8%. Portland cement's chemistry is activated in the presence of water. Through a chemical reaction of cement and water called hydration, the paste hardens and gains strength. The character of concrete is determined by the quality of the paste. The strength of the paste, in turn, depends on the ratio of water to cement. The water-cement ratio is the weight of the mixing water divided by the weight of the cement. High-quality concrete is produced by lowering the water-cement ratio as much as possible without sacrificing the workability of fresh concrete. Generally, using less water produces a higher quality concrete provided the concrete is properly placed, consolidated and cured.

The composition of the present invention uses low-density aggregate, graded and conforming to ASTM C330. Lightweight aggregate is produced by heating particles of shale, clay, or slate to about 1,200 degrees C. (2,160 degrees F.) in a rotary kiln. At this temperature, the raw material bloats, forming a vesicular structure that is retained upon cooling. The individual vesicles are to various degrees not interconnected and produce a dilation of as much as or more than 50%, which is retained upon cooling. Lightweight aggregate is initially more costly than normal density aggregate, however, because of its structural efficiency, lightweight aggregate can act in a more effective manner in concrete to achieve some desired end results.

For example, these vesicular lightweight manufactured aggregates have a stiffness that is similar to the stiffness of the cement paste matrix, thereby tending to create a uniform stress distribution within the concrete. Normal density aggregates have stiffness modulus up to 10 times that of the matrix, which results in high stress concentrations forming at the aggregate-paste interface. Normal-density concrete has a typically weak interfacial layer that is frequently the site of micro crack initiation. With lightweight concrete, this weak interfacial layer is usually not present and, as a result, a lower level of micro cracking is evident. The reduced stiffness of the lightweight aggregates does, however, result in the stiffness of the concrete being reduced as well.

Currently manufactured lightweight aggregates are similar to those first used for concrete ship construction some eight decades ago. Over the last 80 years, the method of manufacturing lightweight aggregates using the rotary kiln has not changed significantly. Production of lightweight aggregates makes use of readily available shale, clay, and slate, which do not compete with our limited supply of good-quality normal density aggregates. The economic and potential future usage depends on how well design professionals are aware of the unique properties of lightweight concrete and how it can be incorporated in imaginative ways to meet our future building needs.

Typical lightweight concrete mixes are about 25% to about 50% lighter than concrete, having a density from about 60 pounds to about 115 pounds per cubic foot. The present invention uses the aggregates conforming to ASTM C330, including Arkalite, Utelite, Norlite, Stalite and other readily available lightweight aggregates. With all composition of the present invention, the weight of the concrete product will range from 70 pounds to 115 pounds per cubic foot (ppcf) (1280 to /840 kg/m³), preferably about 80 pounds per cubic foot (ppcf) depending upon the strength, air content, aggregate density and mix proportions.

The composition of the present invention also contains water-reducing admixtures meeting ASTM C 494. Preferably, the present invention uses third generation water reducers, mostly derived from a family of polymers known as polycarboxylates. Chemists note a “comb” structure in polycarboxylates and related compounds adapted for dispersants. A comb refers to a polymer's molecular architecture, whereby a polycarboxylate or similar compound is used as a backbone to which other groups of the molecules can be attached. Comb polymer science promises concrete applications significantly beyond water reduction. Chemists and concrete practitioners worldwide note that these dispersing agents can be modified to serve a broad menu of conditions ready-mix and precast producers, and concrete contractors, encountered in plants and at job sites. The most frequently cited benefits include the ability to reduce water at higher rates, in a range of about 30% to about 40%, hence optimizing cement and cementitious materials; maintain slump with little set retardation, substantial set retardation is a pitfall often associated with established water reducers mix compatibly with a far greater range of cement types, pozzolans and other admixtures and it accommodates higher dosage rates of fly ash and ground granulated blast-furnace slag to replace Portland cement. Typically, such polymers are polycarboxylate, sulfonate of lignins, melamine, and naphthalene formaldehyde.

Polycarboxylate is a new generation super plasticizer based on polycarboxylate technology. This product is designed to provide normal to high water reduction, while providing excellent flowability during placement, and excellent slump retention without affecting initial setting time. This product incorporates the latest state-of-the-art technology in high performance concrete.

Sulfonates of lignins are used as a dispersants in manufacturing concrete admixtures. One of the features of lignin sulfonates is that they retard the setting time of concrete. When the concrete additive maker uses lignin sulfonates it is possible to adjust this property. This is the major use for lignin sulfonates at the present time. Melamine base is a super plasticizer that dramatically increases the workability of concrete by its powerful deflocculating and dispersing effect. It also acts catalytically to increase the rate of hardening of the cement particles thereby leading to higher early strength. These combined effects can be utilized to obtain a significant reduction in free water content or to produce self-compacting, high workability flowing concrete, which has increased early strength.

Naphthalene formaldehyde produces increased compressive strength and workability of the concrete. As a water reducer it allows mixes with higher solids slurries. It works as a viscosity reducer of cement slurry by dispersing and wetting the cement particles.

One of these plasticizer types (e.g. polymer based flow agents, polycarboxylates, sulfonate of lignins, melamine, or naphthalene formaldehyde) may be used in the composition of the present invention. A water-reducing admixture in powder form is added to the mix to increase flowability, ease of placement, and also to increase high early strength. The water-reducing admixture will have to be of a type that does not retard the setting of the mix, as one of the features of the present invention is faster setting than normal concrete. A polymer based flow agent that meets the criteria as a plasticizer mix may also be used. The plasticizer dosage will be about 1% to about 2% on the weight of the cement in the mix.

In one embodiment of the present invention, the composition contains a set controlling admixture accelerator. Set controlling admixture accelerators, meeting ASTM C 494, Type C, are chemicals that reduce the initial set time of concrete and are recommended in cold weather. Set controlling admixture accelerators do not act as an antifreeze; rather, they speed up the strength gain and make the concrete stronger to resist damage from freezing. Each drop of ten degrees in temperature below 70 degrees F. (the temperature for which all concrete is designed) substantially delays setting and the rate of strength development. A drop to 50 degrees will reduce the one-day strength by almost 40%, while a drop to 40 degrees will reduce the strength more than 60%. Tests show that it takes 2½ days to develop the same strength at 40 degrees that can be developed in only one day at 70 degrees.

Accelerators are also used in fast track construction. The composition of the present invention may contain calcium formate. Calcium chloride is the most common and least expensive accelerator for non-reinforced concrete and is specified at not more than 2% by the weight of the cement. The addition of 2% calcium chloride will more than offset the losses in strength that normally result from temperatures as low as about 40 degrees or about 50 degrees. Because of its corrosion potential, calcium chloride-especially in prestressed concrete has been strictly limited in use. ACI Committee 222 (1988) has determined that total chloride ions should not exceed 0.08% by mass of cement in prestressed concrete.

Calcium formate, also an accelerator, may be used in the composition of the present invention to help adjust and control the setting time. Ideally the final set time will be about 3 to 5 hours, preferably 3½ hours after poured. Calcium formate content may vary from about 0% to about 6%, preferably at about 2% by weight of cement.

In another embodiment, the composition of the present invention may contain calcium aluminate cements to control and accelerate the setting time. Calcium aluminate cements may be used as the primary binder or in combination with other reactive minerals to form specialty binder systems with unique properties. These combinations may be used in many construction products such as tile adhesives, self-leveling underlayments, concrete patching materials and specialty mortars. As the primary binder, calcium aluminate cements react with most mineral and organic additives to achieve controllable set and flow with exceptional early compressive strength. Calcium aluminate cement additions to Portland cement will accelerate the initial set from hours to minutes depending on the type of Portland cement source. In the present invention, calcium aluminate cements may be used in conjunction with other accelerants such as calcium formate. The amount of each may be directly related to the white cement used, as cements from different origins may contain different amounts of gypsum. This may determine an adjustment in the counter weight formulation of the present invention. The amount used in the composition of the present invention will range from about 0% to about 6% of the total formulation, preferably about 2%. A person of ordinary skill in the art will understand that other types of set controlling admixtures including, but not limited to, calcium chloride, calcium nitrate, calcium thiosulfate, triethanolamine, and other non-chloride accelerators, can be used in the formulation of the present invention without departing from the scope and spirit of the invention.

The composition of the present invention may also contain metakaolin providing superior pozzolanic performance. Metakaolin is derived from purified kaolin clay and is a white, amorphous, alumino-silicate, which reacts aggressively with calcium hydroxide, which is very similar to silica fume. Metakaolin provides superior pozzolanic performance that contributes to the improved strength, durability, chemical resistance, alkali-silica reaction mitigation, water absorption, efflorescence control, and aesthetics of quality concrete and cement based materials. Metakaolin will also enhance the concrete rheology, providing a smoother, creamier mix that improves the handling and finishing characteristics of the concrete. Using metakaolin in the formulation of the present invention increases strength, produces a denser mix, reduces water absorption and provides a creamier and easier to finish mix of the end product. The composition of the present invention has metakaolin content between about 1% and about 15% of cement content, preferably at about 4%. Metakaolin is sold under the designations “PowerPozz” and “Metamax” and can be used in the formulation of the present invention. A person of ordinary skill in the art will understand that other types of metakaolin and other types of pozzolans including, but not limited to, silica fume and kaolin, can be used in the formulation of the present invention without departing from the scope and spirit of the present invention.

The formulation of the present invention can comprise an air-entraining admixture, meeting ASTM C 260. The inclusion of air-entraining admixtures (AEAs) improves freeze/thaw durability, aids pumpability, improves workability, and lowers the density of concrete. The AEA dose is normally specified to range about 5% to about 9% air volume in the mix, with air content limit set to a maximum of about 22% by ASTM C-150. Air-entraining agents entrain small air bubbles in the concrete, which enhances durability in freeze-thaw cycles, especially relevant in cold climates. While some strength loss typically accompanies increased air in concrete, it generally can be overcome by reducing the water-cement ratio via improved workability (due to the air-entraining agent itself) or through the use of other appropriate admixtures. Air-entrained concrete is produced through the use of air-entraining Portland cement, or by introducing air-entraining admixtures under careful engineering supervision as the concrete is mixed on the job. The amount of entrained air is usually about 5% to about 8% of the volume of the concrete, but may be varied as required by special conditions. The use of air-entraining agents results in concrete that is highly resistant to severe frost action and cycles of wetting and drying or freezing and thawing and has a high degree of workability and durability.

In one embodiment, the formulation of the present invention does not contain an air-entraining admixture. In another embodiment, an air-entraining admixture may be added to the formulation of the present invention to enable end products to be used in the outdoors and subject to freeze and thaw. The air-entraining admixture may be added with a content between about 2% to about 8%, preferably about 5%. A person of ordinary skill in the art will understand that any type of commercial air-entraining admixtures can be used in the formulation of the present invention without departing from the scope and spirit of the present invention.

The formulation of the present invention can also comprise a cement modifier to improve bond strength, mechanical strength, water and abrasion resistance, freeze/thaw resistance, chemical resistance, resistance to discoloration, and faster curing. In one embodiment, of the present invention a latex cement modifier including, but not limited to, styrene based polymers and copolymers, acrylic-based polymers and copolymers, polyvinyl acetates, polyepoxides, polyurethanes, and butadiene rubbers, may be added to the formulation of the present invention. The latex cement modifier is added in a cement content about 2% to about 15%, preferably at about 6%.

In one embodiment of the present invention, the mixture is designed for casing a countertop in an indoor setting. The mixture comprises a white Portland cement Type I of about 20% to about 50% of the mixture, a lightweight aggregate of about 40% to about 80% of the mixture, a plasticizer of about 1% to 2% of the cement, a set controlling accelerator of up to about 6% of the cement, preferably about 2% of the cement, a cement modifier about 2% to 15% the cement, preferably about 6% of the cement, and a pozzolan about 1% to 10% of the cement, preferably about 4% of the cement. In this embodiment, the plasticizer can be polycarboxylate, sulfonate of lignins, melamine, or naphthalene formaldehyde; the set controlling accelerator can be calcium aluminate, calcium formate, calcium nitrate, calcium thiosulfate, triethanolamine, or calcium chloride; the cement modifier is a latex polymer wherein the polymer can be styrene based polymer and copolymer, acrylic based polymer and copolymer, polyvinyl acetate, polyepoxide, or butadiene rubber; and, the pozzolan can be a metakaolin, commercially designated as “PowerPozz” or “Matamax”. This embodiment of the formulation also can contain an air entrainer of about 2 to 8% of the cement, preferably about 4% of the cement.

All the components of the composition in the present invention should meet United States Standards ASTM. The Portland cements Type I, Type II, and Type III meet ASTM C-150, the Portland cements Type K, Type M, Type N and Type S meet ASTM C-845, the lightweight aggregate meets ASTM C-330, the plasticizers meets ASTM C-494, the accelerators meet ASTM C-494, and the air entrainers meet ASTM C-260.

The dry mixture of the lightweight concrete formulation in the present invention is used to make lightweight concrete products including cast-in-place and pre-cast concrete products. These products includes, but are not limited to, acid staining, concrete countertops, overlays, stamping, concrete engraving, and vertical walls. In one embodiment, the dry mixture of the present invention is used to make cast-in-place lightweight concrete countertops. Upon finishing cabinets on which a lightweight concrete countertop is to be cast, a support including a plurality of wood poles or the like is to be installed to support the weight of the countertop, then a base is to be prepared upon which the countertop is to be cast. The base can be a fiberboard, preferably a ¾-inch thick medium density fiberboard, is cut to form the desired shape of the countertop to be cast. A sink hole is to be formed by cutting the base to fit a desired sink on the countertop, as well as a plurality of holes for fitting sink faucets. After the base is fastened onto the support with screws or other means, a wire mesh substantially similar to the shape of the desired countertop is prepared and fastened onto the base with screws or other means. The wire mesh is preferably a galvanized reinforced steel panel of which the wires are ⅜ inch in diameter. Styrofoam is taped along the edges of the base to be used as protectors of the countertop when casting. The sink hole is covered with a Styrofoam forming the same shape as the sink and the sink faucet holes are covered with plastic pipes forming the same shape as the sink faucets, the apertures between the Styrofoam and the sink hole and the faucet hole are sealed with Silicone sealing and the like.

To make a smooth paste with a dry mixture of the lightweight concrete formulation in the present invention, a designated amount of dry mixture is mixed well with a designated amount of water in a concrete mixer. During the mixing process, a coloring agent can be added to the mixture. In one embodiment of the process of the present invention, a 40 pound dry mixture is mixed with about 4 quarts of water in a concrete mixer for about 5 minutes, then a coloring agent is added to the mixture and continues mixing for another 3-4 minutes or until the mixture becomes a smooth paste.

Upon providing the base with fastened wire mesh and a smooth paste of lightweight concrete mixture, the smooth paste is then placed on the base and troweled to cover the entire area of the base to form the desired countertop. After achieving the desired smoothness of the paste on the base, the paste is allowed to solidify overnight, and then the protectors, the sink hole cover, and the plastic sink faucet pipes are removed. The countertop is then completed after sanding and finishing using diamond pads and the like.

A person of ordinary skill in the art will understand, that the process of making a lightweight concrete product by using the dry mixture of the present invention can be performed with similar construction means and techniques to achieve desired results needed or demanded by particular products.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore, contemplated that the claims will cover any such modifications or embodiments that fall within the scope of the invention.

What is claimed is:

1. A lightweight cementitious composition comprising a dry mixture of:
a hydraulic cement component wherein the hydraulic cement components comprises only one type of hydraulic cement; and
a lightweight aggregate component wherein the bulk density of the aggregate component is about 40 to about 60 pounds per cubic foot.

2. The composition of claim 1 wherein the hydraulic cement component is white Portland cement Type I.

3. The composition of claim 1 wherein the only one hydraulic cement component is Type I cement, Type II cement, Type III cement, Type S cement, Type N cement, Type M cement, or Type K cement.

4. The composition of claim 1 wherein the hydraulic cement component is about 20% to about 50% of the mixture.

5. The composition of claim 1 wherein the cement component meets standards specified in ASTM C-150.

6. The composition of claim 1 further comprising a dry mixture of:
a plasticizer having a content of about 1% to about 2% of the cement component;
a set control accelerator having a content of about 6% of the cement component;
a pozzolan having a content of about 1% to about 10% of the cement component; and
a cement modifier having a content of about 2% to about 15% of the cement component.

7. The composition of claim 6 wherein the plasticizer is polycarboxylate, sulfonate of lignins, melamine, or naphthalene formaldehyde.

8. The composition of claim 6 wherein the plasticizer meets standards specified in ASTM C-494.

9. The composition of claim 6 wherein the set control accelerator is calcium aluminate, calcium formate, calcium nitrate, calcium thiosulfate, triethanolamine, or calcium chloride.

10. The composition of claim 6 wherein the set control accelerator meets standards specified in ASTM C-494.

11. The composition of claim 6 wherein the pozzolan is metakaolin designated as “PowerPozz” or “Metamax”.

12. The composition of claim 6 wherein the cement modifier is a latex polymer selected from the group consisting of styrene based polymer and copolymer, acrylic based polymer and copolymer, polyvinyl acetate, polyepoxide, and butadiene rubber.

13. The composition of claim 6 further comprising an air entrainer.

14. The composition of claim 13 wherein the air entrainer content is about 2% to about 8% of the cement component in the mixture.

15. The composition of claim 6 wherein the air entrainer meets standards specified in ASTM C-260.

16. An improved lightweight cementitious composition comprising a dry mixture of:
a hydraulic cement component wherein the hydraulic cement components comprises only one type of hydraulic cement;
a lightweight aggregate component wherein the bulk density of the aggregate component is about 40 to about 60 pounds per cubic foot;
a plasticizer;
a set control accelerator;
a pozzolan; and
a cement modifier.

17. The composition of claim 16 wherein the hydraulic cement component is selected from the group consisting of Type I cement, Type II cement, Type III cement, Type S cement, Type N cement, Type M cement, and Type K cement.

18. The composition of claim 16 wherein the hydraulic cement component is white Portland cement Type I.

19. The composition of claim 16 wherein the cement component content is about 20% to about 50% of the mixture.

20. The composition of claim 16 wherein the cement component meets standards specified in ASTM C-150.

21. The composition of claim 16 wherein the plasticizer is polycarboxylate, sulfonate of lignins, melamine, or naphthalene formaldehyde.

22. The composition of claim 16 wherein the plasticizer content is about 1% to about 2% of the cement component.

23. The composition of claim 16 wherein the plasticizer meets standards specified in ASTM C-494.

24. The composition of claim 16 wherein the set control accelerator is calcium aluminate or calcium formate, calcium nitrate, calcium thiosulfate, triethanolamine, or calcium chloride.

25. The composition of claim 16 wherein the set control accelerator content is about 6% of the cement component.

26. The composition of claim 16 wherein the set control accelerator meets standards specified in ASTM C-494.

27. The composition of claim 16 wherein the pozzolan is metakaolin designated as “PowerPozz” or “Metamax”.

28. The composition of claim 16 wherein the pozzolan content is about 1% to about 10% of the cement component.

29. The composition of claim 16 wherein the cement modifier is a latex polymer selected from the group consisting of styrene based polymer and copolymer, acrylic based polymer and copolymer, polyvinyl acetate, polyepoxide, and butadiene rubber.

30. The composition of claim 16 wherein the cement modifier content is about 2% to about 15% of the cement component.

31. The composition of claim 16 further comprising an air entrainer.

32. The composition of claim 31 wherein the air entrainer content is about 2% to about 8% of the cement component in the mixture.

33. The composition of claim 31 wherein the air entrainer meets standards specified in ASTM C-260.

34. A formulation of an improved lightweight cement dry mixture having a cement component and a lightweight aggregate, comprising a mixture of:
a plasticizer;
a set control accelerator;
a pozzolan; and
a cement modifier.

35. The composition of claim 34 wherein the plasticizer is polycarboxylate, sulfonate of lignins, melamine, or naphthalene formaldehyde.

36. The composition of claim 34 wherein the plasticizer content is about 1% to about 2% of the cement component.

37. The composition of claim 34 wherein the plasticizer meets standards specified in ASTM C-494.

38. The composition of claim 34 wherein the set control accelerator is calcium aluminate or calcium formate, calcium nitrate, calcium thiosulfate, triethanolamine, or calcium chloride.

39. The composition of claim 34 wherein the set control accelerator content is about 6% of the cement component.

40. The composition of claim 34 wherein the set control accelerator meets standards specified in ASTM C-494.

41. The composition of claim 34 wherein the pozzolan is metakaolin designated as “PowerPozz” or “Metamax”.

42. The composition of claim 34 wherein the pozzolan content is about 1% to about 10% of the cement component.

43. The composition of claim 34 wherein the cement modifier is a latex polymer selected from the group consisting of styrene based polymer and copolymer, acrylic based polymer and copolymer, polyvinyl acetate, polyepoxide, and butadiene rubber.

44. The composition of claim 34 wherein the cement modifier is in a content of about 2% to about 15% of the cement component.

45. The composition of claim 34 further comprising an air entrainer.

46. The composition of claim 45 wherein the air entrainer content is about 2% to about 8% of the cement component in the mixture.

47. The composition of claim 45 wherein the air entrainer meets standards specified in ASTM C-260.

48. An improved formulation of a lightweight cement mixture comprising:
a white Portland cement Type I having a content of about 20% to about 50% of the mixture;
a lightweight aggregate having a content of about 40% to about 80% of the mixture;
a plasticizer having a content of about 1% to about 2% of the white Portland Cement Type I;
a set controlling admixture having a content of about 6% of the white Portland Cement Type I;
a cement modifier having a content of about 2% to about 15% the white Portland Cement Type I; and
a pozzolan having a content of about 1% to about 10% of the white Portland Cement Type.

49. The formulation of claim 48 further comprising an air entrainer having a content of about 2% to about 8% white Portland Cement Type I.

50. The composition of claim 48 wherein the air entrainer meets standards specified in ASTM C-260.

51. The composition of claim 48 wherein the plasticizer is polycarboxylate, sulfonate of lignins, melamine, or naphthalene formaldehyde.

52. The composition of claim 48 wherein the plasticizer meets standards specified in ASTM C-494.

53. The composition of claim 48 wherein the set control accelerator is calcium aluminate; calcium formate; calcium nitrate; calcium thiosulfate; triethanolamine or calcium chloride.

54. The composition of claim 48 wherein the set control accelerator meets standards specified in ASTM C-494.

55. The composition of claim 48 wherein the pozzolan is metakaolin designated as “PowerPozz” or “Metamax”.

56. The composition of claim 48 wherein the cement modifier is a latex polymer selected from the group consisting of styrene based polymer and copolymer, acrylic based polymer and copolymer, polyvinyl acetate, polyepoxide, and butadiene rubber.

57. A method of making a lightweight concrete product comprising the steps of:
providing a dry mixture wherein the dry mixture comprises a hydraulic cement component wherein the hydraulic cement components comprises only one type of hydraulic cement, a lightweight aggregate component wherein the bulk density of the aggregate component is about 40 to about 60 pounds per cubic foot, a plasticizer, a set control accelerator, a pozzolan, and a cement modifier;
providing a support for the lightweight concrete product;
providing a base;
fastening the base onto the support for the lightweight concrete product;
providing a wire mesh;
fastening the wire mesh onto the base;
providing a plurality of protectors;
attaching the protectors along the edges of the base;
mixing a designated amount of the dry mixture of the lightweight concrete composition with designated amount of water in a concrete mixer;
adding one or a plurality of color agents into the mixture and mixing the color agents in the concrete mixer until the mixture becomes a smooth paste;
placing the smooth paste onto the base;
troweling the paste to desired smooth surface;
allowing the paste to dry to a sufficient hardness;
performing sanding and finishing; and
removing protectors.

58. The method of claim 57, wherein the dry mixture comprises a hydraulic cement component wherein the hydraulic cement components comprises only one type of hydraulic cement and a lightweight aggregate component wherein the bulk density of the aggregate component is about 40 to about 60 pounds per cubic foot.

59. The method of claim 57, wherein the dry mixture comprises a white Portland cement Type I having a content of about 35% to about 40% of the mixture, a lightweight aggregate having a content of about 55% to about 60% of the mixture, a plasticizer having a content of about 1% to about 2% of the white Portland Cement Type I, a set controlling admixture having a content of about 6% of the white Portland Cement Type I, a cement modifier having a content of about 2% to about 15% the white Portland Cement Type I, and a pozzolan having a content of about 1% to about 10% of the white Portland Cement Type.
